(19) United States
(12) Patent Application Publication
(10) Pub. No.: US 2011/0310127 A1
(43) Pub. Date: Dec. 22, 2011

(54) IMAGE PROCESSING APPARATUS, IMAGE PROCESSING METHOD AND PROGRAM

(75) Inventor: Satoshi Arai, Hamura-shi (JP)

(73) Assignee: KABUSHIKI KAISHA TOSHIBA, Tokyo (JP)

(21) Appl. No.: 13/097,559

(22) Filed: Apr. 29, 2011

(30) Foreign Application Priority Data
Jun. 16, 2010 (JP) 2010-137671

(51) Int. Cl. G09G 5/00

(52) U.S. Cl. 345/660

(57) ABSTRACT

According to one embodiment, an image processing apparatus includes an image input module, an enlargement module and an output module. The image input module is configured to input an image and information of a focus point of the image. The enlargement module is configured to enlarge a part around the focus point of the image, based on the information of the focus point. The output module is configured to output an enlarged image in which the part around the focus point is enlarged by the enlargement module.

### CROSS-REFERENCE TO RELATED APPLICATIONS

This application is based upon and claims the benefit of priority from Japanese Patent Application No. 2010-137671, filed Jun. 16, 2010; the entire contents of which are incorporated herein by reference.

### FIELD

Embodiments described herein relate generally to an image processing apparatus, an image processing method and program, which correct images.

### BACKGROUND

With recent spread of digital apparatuses such as digital cameras and digital televisions, the user has increasing opportunities to output and view image data taken by digital cameras on a large screen of digital televisions, rather than to print the image data on photographic paper.

An optimum viewing distance between the viewer and the screen is set for digital televisions, in accordance with the size of the screen. It is said that the optimum viewing distance is about three times as long as the height of the screen, in thin digital televisions. The optimum viewing distance relates to the characteristic of human eyes. Generally, sight of human eyes decreases toward the outside of the field of vision. When humans usually view an object, humans can recognize an object falling within a viewing angle of 45° as an image, but cannot recognize the shape or color of objects existing outside the range. Therefore, the optimum viewing distance is a distance at which the viewer can view the digital television with a viewing angle of about 33°. In this state, the viewer views the digital television in a light gazing state. In this state, the viewer recognizes the size, the gradation, the outline, and the color of the subject displayed on the screen.

However, when the viewer views an image taken by the digital camera, there are many cases where the user has an impression different from an impression which the user had when the image was taken. For example, there are cases where the size of the subject shown in the photograph is smaller than the size of the subject which the user saw with the naked eyes when the photograph was taken. This is caused by difference between “an image seen with the naked eyes (hereinafter referred to as “memory image”)”, “a photographed image (hereinafter referred to as “photograph image”)”, and “expected image”.

The human eyes have characteristic of unconsciously enlarging the gazed subject, even when the user views a scene including the subject to be photographed. This is because humans combines images obtained from various viewpoints and at various viewing angles in the brain, and prepares a memory image with feelings.

Due to such characteristic of the human eyes and image processing in the brain, there is difference between the memory image, the photographed image, and the expected image. Specifically, for the users who are not skilled in photographing, it is difficult to take a photograph image that gives a feeling as if they are in the photographed scene, that is, a photograph image which has little difference from the memory image or the expected image, with understanding of the above characteristic of the human eyes.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an example block diagram illustrating a schematic structure of a digital television broadcasting receiver according to a first embodiment.

FIG. 2 is an example diagram illustrating relation between an optimum viewing distance and a viewing angle according to the first embodiment.

FIG. 3 is an example diagram illustrating each viewing angle in a screen according to the first embodiment.

FIG. 4 is an example diagram illustrating image data curves according to the first embodiment.

FIG. 5 is an example flowchart illustrating processing of preparing an expected image according to the first embodiment.

FIG. 6 is an example diagram illustrating an example of the expected image according to the first embodiment.

FIG. 7 is an example diagram illustrating a focus point in image data according to a second embodiment.

### DETAILED DESCRIPTION

Various embodiments will be described hereinafter with reference to the accompanying drawings.

In general, according to one embodiment, an image processing apparatus includes an image input module, an enlargement module and an output module. The image input module is configured to input an image and information of a focus point of the image. The enlargement module is configured to enlarge a part around the focus point of the image, based on the information of the focus point. The output module is configured to output an enlarged image in which the part around the focus point is enlarged by the enlargement module.

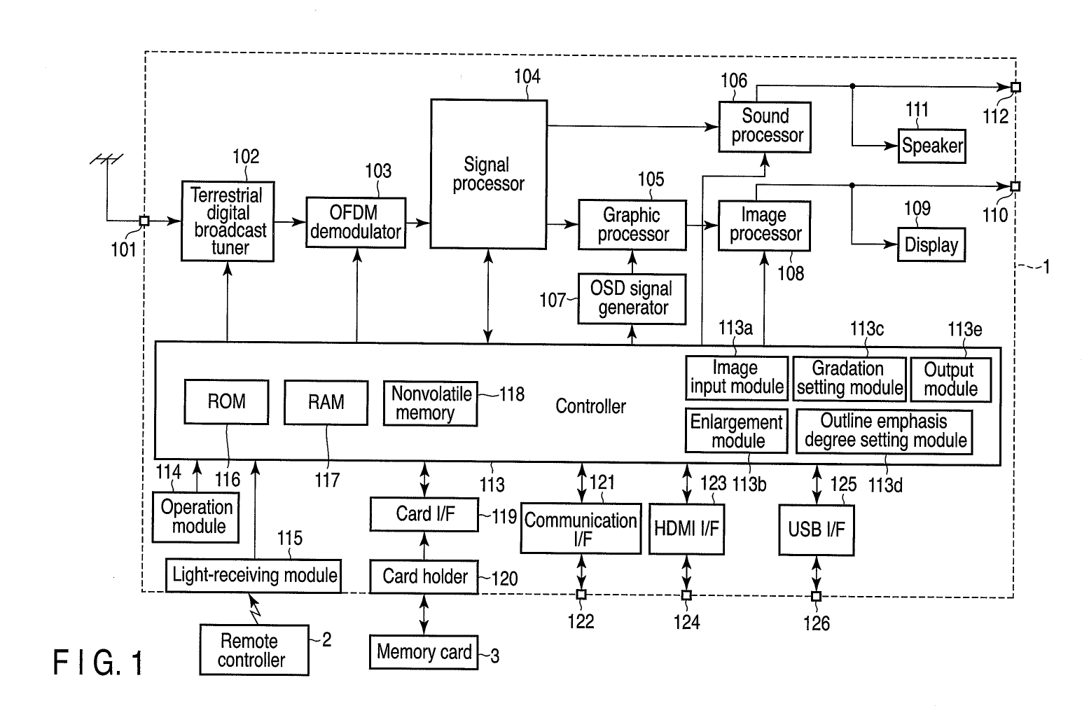

A first embodiment will be described hereinafter with reference to drawings. FIG. 1 is a block diagram illustrating a schematic structure of a digital television broadcasting receiver 1 (hereinafter referred to as “broadcasting receiver 1”) according to the first embodiment. Specifically, a terrestrial digital broadcast signal received by a terrestrial digital broadcast reception antenna is supplied to a terrestrial digital broadcast tuner 102 through an input terminal 101. The terrestrial digital broadcast tuner 102 selects a broadcasting signal of a channel desired by the user. The broadcasting signal selected by the terrestrial digital broadcast tuner 102 is supplied to at OFDM (orthogonal frequency division multiplexing) demodulator 103, demodulated into a digital image signal and sound signal, and then outputted to the signal processor 104.

The signal processor 104 selectively performs predetermined digital signal processing for the digital image signal and digital sound signal supplied from the OFDM demodulator 105, and outputs the signals to a graphic processor 105 and a sound processor 106.

The graphic processor 105 has a function of overlaying an OSD signal generated by an OSD (on screen display) signal generator 107 on the digital image signal supplied from the signal processor 104, and outputting the signal. The graphic processor 105 can selectively output the output image signal of the signal processor 104 and the output OSD signal of the OSD signal generator 107.

The digital image signal outputted from the graphic processor 105 is supplied to an image processor 108. The image signal processed by the image processor 108 is supplied to a display (monitor) 109 and an output terminal 110. The display 109 displays an image based on the image signal. When an external device is connected to the output terminal 110, the image signal supplied to the output terminal 110 is inputted to the external device. The display 109 displays images of a program, based on the broadcasting signal selected by the terrestrial digital broadcast tuner 102 by switching the channel to a channel selected by the user with a remote controller 2.

The sound processor 106 converts the input digital sound signal into an analogue sound signal of a format which can be played back by speakers 111. Then, the sound processor 106 outputs the signal to speakers 111 to playback sound, and guides the signal to the outside through an output terminal 112.

A controller 113 controls all the operations of the broadcasting receiver 1 including the above receiving operations. The controller 113 includes a CPU (central processing unit) and the like. The controller 113 receives operation information from an operation module 114, or operation information which is transmitted from the remote controller 2 and received through a light-receiving module 115, and controls the modules to reflect the operation.

The controller 113 mainly uses a ROM (read only memory) 116 which stores a control program to be executed by the CPU, a RAM (random access memory) 117 which provides the CPU with a work area, and a nonvolatile memory 118 which stores various setting information and control information.

The controller 113 is connected to a card holder 120, to which a memory card 3 can be attached, through a card I/F (Interface) 119. Thereby, the controller 113 can transmit and receive information with the memory card 3 attached to the card holder 120 through the card I/F 119.

In addition, the controller 113 is connected to a LAN (local area network) terminal 122 through a communication I/F 121. Although an example of wired connection through the LAN terminal 122 is shown as the communication I/F 121, the communication I/F 121 is not limited to this example. The controller 113 can transmit information on the Internet through the communication I/F 121. The controller 113 is also connected to an HDMI terminal 124 through an HDMI (High Definition Multimedia Interface) I/F 123. The controller 113 can transmit and receive information with an external device through the HDMI I/F 123. In addition, the controller 113 is connected to a USE terminal 126 through a USE (universal serial bus) I/F 125. The controller 113 can transmit information through the USE I/F 125.

The following is explanation of a general human viewing angle. The range falling within a viewing angle of 45° is a range in which humans can recognize an object. Specifically, the range is a range in which humans can recognize the outline and the color of an object by the brain. The range within a viewing angle of 30° is a range in which humans lightly gaze an object. Specifically, the range is a range in which humans can view a movie and the like with no problem. The range within a viewing angle of 24° is a range in which humans gazes an object. Specifically, the range is a range in which humans distinguishes an object with concentration.

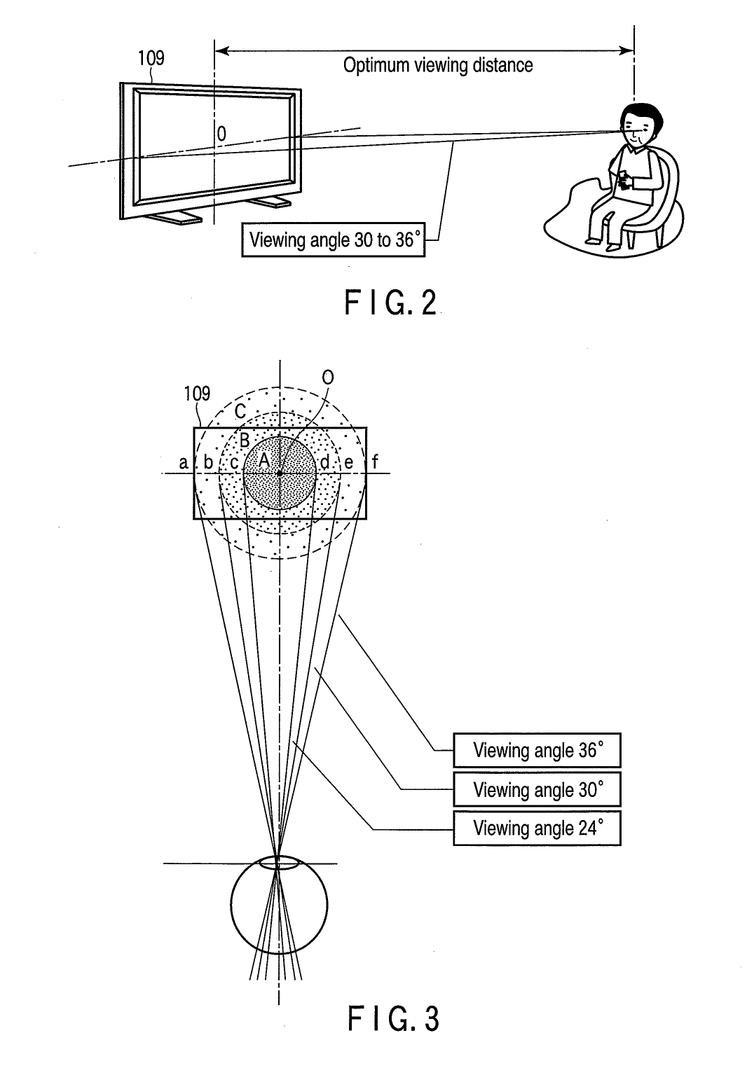

FIG. 2 is a diagram illustrating relation between an optimum viewing distance and a viewing angle when the viewer views an image in a state of lightly gazing the screen of the display 109. Suppose that the viewer views the center position 0 of the screen of the display 109. It is generally said that the optimum viewing distance of a thin liquid crystal display is about three times the height of the screen. For example, the optimum viewing distance is 1.3 m when the size of the screen is 32 inches, and the optimum viewing distance is 1.8 m when the size of the screen is 46 inches. At the optimum viewing distance, the maximum viewing angle in the width direction of the screen is about 33°. The viewer can recognize the whole screen of the display 109, when the maximum viewing angle is around 33°. Therefore, at the optimum viewing distance, the viewer can view the part around the center of the screen of the display 109 in a light gazing state, while the part close to the outer edge of the screen is viewed in a recognizable state.

In the first embodiment, explained is the case where the eyesight of the viewer is 1.0, and the viewer views digital broadcasting with a size of 1920×1080 on the liquid crystal display 109 of 46 inches. In the first embodiment, suppose that the optimum viewing distance of the display 109 is set to a distance at which the maximum viewing angle in the width direction of the screen of the display 109 is 36°. The optimum viewing distance in this state is about 156 cm, when it is calculated based on the horizontal width of the screen of the display 109 of 46 inches. Although the first embodiment is explained with an example in which the maximum viewing angle is 36°, the embodiment is not limited to it.

FIG. 3 is a diagram illustrating an area of each viewing angle when the viewer views the screen of the display 109 at the optimum viewing distance. FIG. 3 illustrates areas of the viewing angles 24°, 30°, and 36°, in the screen of the display 109. Suppose that the viewer views the center position 0 of the screen of the display 109. This is because a notable image is generally displayed around the center position 0 of the screen. The area less than a viewing angle of 24° is an area which the viewer gazes. The area ranging from a viewing angle of 24° to less than 30° is an area which the viewer lightly gazes. The area ranging from a viewing angle of 30° to less than 36° is an area, an image in which the viewer can recognize. Although the eyesight of humans may be elliptical when the human views an image with both eyes, the areas of the viewing angles are explained as concentric circles to simplify the explanation.

In FIG. 3, in the width direction running through the center position 0 of the screen, suppose that the outer edge in the width direction of the screen of the display 109, that is, one end of the outer edge of the range of the viewing angle 36° is point a, and the other end of the outer edge is point f. Suppose that one end of the outer edge of the range of the viewing angle 30° is point b, and the other end of the outer edge is point e. Suppose that one end of the outer edge of the range of the viewing angle 24° is point c, and the other end of the outer edge is point d. Further, the area less than the viewing angle 24° is area A, the area ranging from the viewing angle 24° to less than 30° is area B, and the area ranging from the viewing angle 30° to less than 36° is area C.

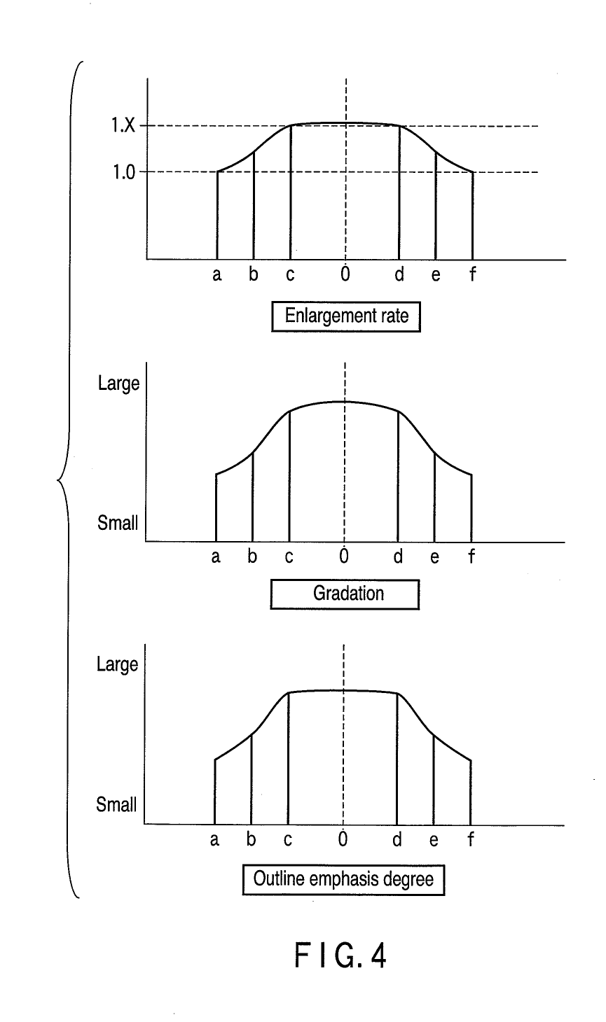

FIG. 4 is a diagram illustrating a plurality of data curves used for correcting image data. In the first embodiment, suppose that the image data has a focus point 0 in the center position of the photograph image. The upper part of FIG. 4 illustrates an enlarged data curve for the areas. The controller 113 (enlargement module 113b) corrects an enlargement rate of each area in the image data. In the area A in which the focus point 0 exists and the gazing degree of the viewer is high, there is tendency that the image is viewed in an enlarged state as expected image. Therefore, the area A has large enlargement rate since the image is enlarged. Specifically, the enlargement rate of the area A is larger than the enlargement rates of the area B and the area C. Different enlargement rates are set for the three divided areas (area A, area B, and area C) with the focus point 0 used as the center. The enlargement rate of the area B increases along a direction going from the point b toward the point c, or from the point e toward the point d. The enlargement rate of the area c slowly increases from 1.0, along a direction going from the point a toward the point b, or from the point f to the point e. At the point and the point f, the enlargement rate of the correction data curve is 1.0. Specifically, in the enlargement data curve, the enlargement rate gradually increases in a direction going from the point a toward the focus point 0, or from the point f to the focus point 0. Since there is the possibility that a joint part between parts having different enlargement rates may be unnatural when the enlargement rate is changed in a pulse manner, the enlargement rate is gradually changed as described above, and thereby it is possible to provide an image including less unnatural parts than the case where the enlargement rate is changed in a pulse manner. The enlargement rate curve is obtained by experiments using a testee. The enlargement rate of the image displayed in the area of each viewing angle is determined by the enlargement data curve.

The middle part of FIG. 4 illustrates a gradation data curve in the areas. The controller 113 (the gradation setting module 113) corrects gradation of each area in the image data. In the area A having high gazing degree by the viewer, an image is required to have variety as expected image. Therefore, the area A has large gradation to provide the image with variety. The area A in which the gazing degree by the viewer is high has large gradation. Specifically, the gradation of the area A is larger than the gradations of the area B and the area C. The gradation of the area B increases in a direction going from the point b toward the point c, or from the point e toward the point d. The gradation of the area C slowly increases along a direction going from the point a to the point b, or from the point f to the point e. The gradation of the image displayed in the area of each viewing angle is determined by the gradation data curve.

The lower part of FIG. 4 illustrates an outline emphasis data curve for the areas. The controller 113 (the outline emphasis degree setting module 113) corrects outline emphasis of each area in the image data. In the area A having high gazing degree by the viewer, an image is required to have sharpness as expected image. Therefore, the area A has large outline emphasis degree to provide the image with sharpness. Specifically, the outline emphasis degree of the area A is larger than the outline emphasis degrees of the area B and the area C. The outline emphasis degree of the area B increases in a direction going from the point b toward the point c, or from the point e toward the point d. The outline emphasis degree of the area C slowly increases along a direction going from the point a to the point b, or from the point f to the point e. The outline emphasis data curve is determined by experiments using a testee. The outline emphasis degree of the image displayed in the area of each viewing angle is determined by the gradation data curve.

Although FIG. 4 shows the enlargement data curve, the gradation data curve, and the outline emphasis data curve only with respect to the width direction of the screen, the same is applicable to all the directions, that is, 360°, with the center position 0 of the screen used as the center. Data of the enlargement data curve, the gradation data curve, and the outline emphasis data curve are stored in advance in the nonvolatile memory 118. The viewer can change the correction degree of these curves as desired.

The following is explanation of calculation of the area A, the area B and the area C in the screen which displays an image. The controller 113 calculates the area A, the area B, and the area C in the screen as follows. When an image is outputted to the display 109 of the broadcasting receiver 1, the controller 113 calculates the area A, the area B, and the area C in the screen, on the basis of size information of the display 109 and information of the optimum viewing distance of the display 109, which are stored in the nonvolatile memory 118.

When an image is outputted to, for example, an external display (monitor) connected to the HDMI terminal 124, the controller 113 obtains size information of the display (monitor) from the external display. In addition, the controller 113 obtains information of the optimum viewing distance of the external display, from the external display or the Internet through the communication I/F 121. The controller 113 calculates the area A, the area B, and the area C, based on the size information and the optimum viewing distance information of the external display.

The areas of the area A, the area B, and the area C are proportional to the number of inches of the screen. Specifically, correlation between regions of image data and the area A, the area B, and the area C do not change, regardless of the number of inches of the screen. Therefore, even when the image is outputted to the external display, the controller 113 may use information relating to the area A, the area B, and the area C, which are calculated based on the size information and the optimum viewing distance information of the display 109 stored in the nonvolatile memory 118. The controller 113 divides the image data into three regions corresponding to the calculated area A, the area B, and the area C, and processes for the divided regions. Although the controller 113 divides the image data into three regions based on the viewing angles, the number of regions is not limited to it.

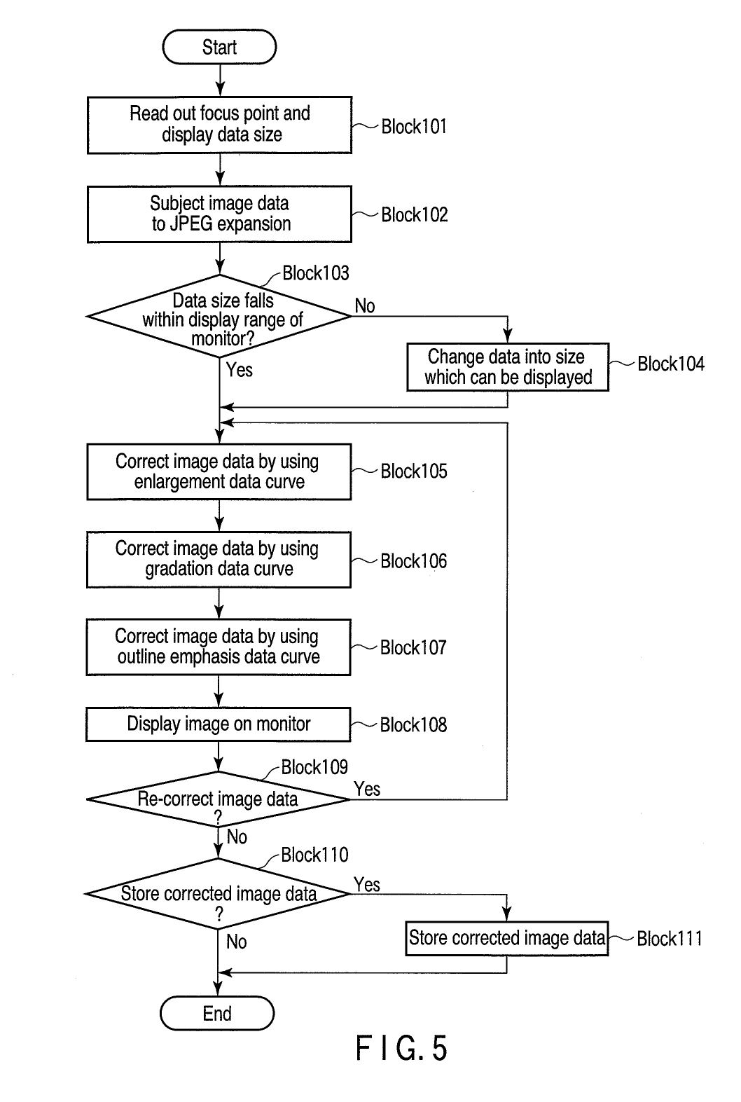

FIG. 5 is a flowchart illustrating processing preparing an expected image according to the first embodiment. FIG. 5 shows the case where an image is outputted to the display 109. First, the controller 113 obtains image data to be displayed on the display 109 from the memory card 3. The controller 113 reads out focus point information and data size information of the image data to be displayed from the memory card 3 (Block 101). The controller 113 functions as image input module 113a, which inputs image data, focus point information and data size information of the image data stored in the memory card 3 to the controller 113.

Next, the controller 113 subjects the image data to JPEG expansion (Block 102). Thereafter, the controller 113 determines whether the size of the image data falls within the display range of the display 109 (Block 103). When the size of the image data does not fall within the display range of the display 109 (Block 103, No), the controller 113 changes the image data to a size which can be displayed on the display 109 (Block 104).

When the size of the image data falls within the display range of the display 109 (Block 103, Yes), or after the size of the image data is changed in the block 104, the controller 113 corrects the image data by using the enlargement data curve (Block 105). The controller 113 functions as image data enlargement module 113b. The controller 113 enlarges image data existing around the focus point, based on the enlargement data curve. Specifically, the controller 113 enlarges the image data, with the enlargement rate of the area A (first area) close to the focus point, which is set larger than the enlargement rates of the area B or the area C (second area) which is more distant from the focus point than the area A is. The controller 113 also enlarges the image data, with the enlargement rate in accordance with the size of the display 109.

Next, the controller 113 corrects the image data by using the gradation data curve (Block 106). The controller 113 functions as image data gradation setting module 113c. The controller 113 increases the gradation of the image data existing around the focus point. Then, the controller 113 corrects the image data by using the outline emphasis data curve (Block 107). The controller 113 functions as image data outline emphasis degree setting module 113d. The controller 113 increases the outline emphasis degree of the image data existing around the focus point. Specifically, the controller 113 corrects the regions of the image data corresponding to the respective areas in the display 109, using the enlargement data curve, the gradation data curve, and the outline data curve. The controller 113 prepares expected image data (corrected image data), by combining the regions which are corrected based on the data curves, with a region which exists outside the correction range and is maintained at a state of the original image data. The controller 113 controls to display the expected image data on the display 109 (Block 108). The controller 113 functions as corrected image data output module 113e. The display 109 functions as display for the corrected image data which is outputted by the controller 113.

The controller 113 determines whether the viewer selects re-correction for the expected image data by using the remote controller 2 (Block 109). When re-correction for the expected image data is selected (Block 109, Yes), the controller 113 returns to the Block 105, and performs re-correction for the expected image data. When the viewer selects re-correction, the controller 113 may increase a correction degree in each area of each data curve by a predetermined rate. In addition, the controller 113 may perform re-correction for the expected image data, based on user's input of desired change of each data curve.

When re-correction for the expected image data is not selected (Block 109, No), the controller 113 controls to display a picture which notifies the user whether the expected image data is to be stored in the memory card separately from the original image data (Block 110). When the viewer selects to store the expected image data (Block 110, Yes), the controller 113 stores the expected image data in the memory card (Block 111). When the viewer does not select to store the expected image data (Block 110, No), or after the expected image data is stored in the memory card in the Block 111, the controller 113 ends display of the expected image data on the display 109.

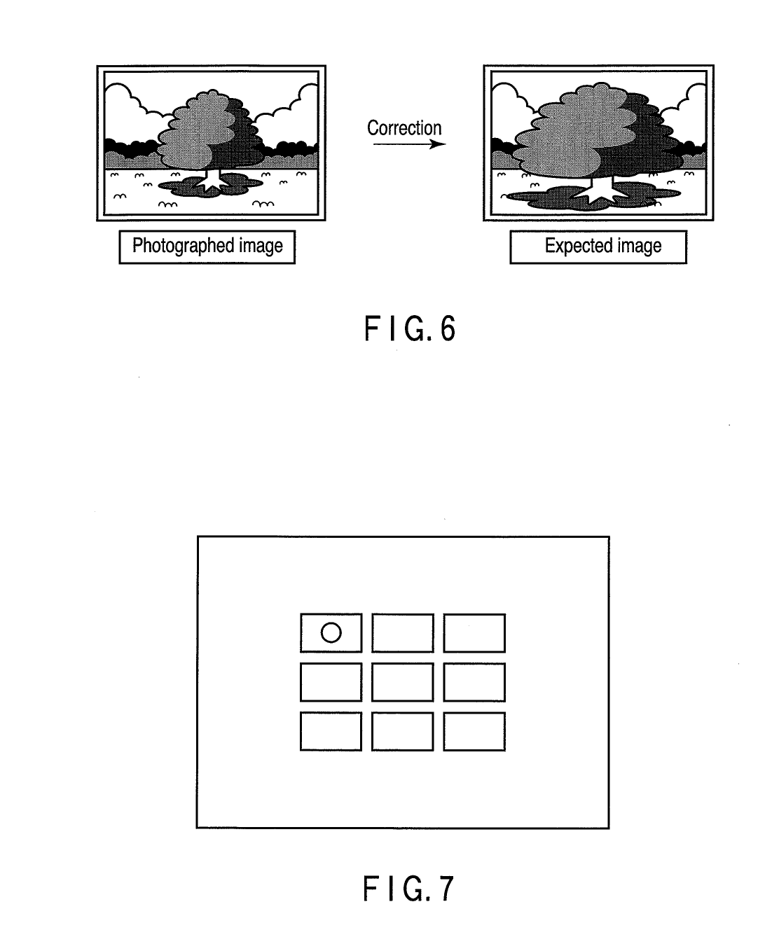

FIG. 6 is a diagram illustrating an example of a photograph image based on image data before correction, and an expected image based on corrected expected image data. The focus point is the center position of the screen in which the photographed subject is shown. In the photograph image, the occupation rate of the subject located in the center position of the image for the whole image is small. On the other hand, in the expected image based on the correction of the first embodiment, the occupation rate of the subject located in the center position of the image for the whole image is large, in the region of the subject image. Therefore, according to the first embodiment, it is possible to suppress decrease in a sense of presence when the image is displayed on the screen. Therefore, even for a photographed image taken by a person which is not skilled in photographing, an expected image that gives a feeling as if the viewer is in the photographed scene is displayed on the screen.

Although the image data is corrected by using the enlargement data curve, the gradation data curve, and the outline emphasis data curve in the first embodiment, the embodiment is not limited to it. Correction for the image data may be performed without at least one of the gradation data curve and the outline emphasis data curve, or a data curve based on other factors may be used.

In addition, although the image data is corrected in the first embodiment to display the image on the screen such as the display 109, the image data may be corrected as part of a photograph edit function of printers or personal computers. In this case, the regions of the image data to be corrected and corresponding to the area A, the area B, and the area C illustrated in FIG. 3 may be calculated in accordance with the size of paper to which the image is outputted, or the regions may be fixed.

Next, a second embodiment will be explained hereinafter. The second embodiment is applicable to the case where the focus point exists in a position other than the center of the image data, unlike the first embodiment FIG. 7 illustrates image data which is obtained by a digital camera, which has nine range finder frames arranged over a wide range to measure the distance to the subject and can he selected at least one focus point from nine focus points without limiting the position of the subject. The image data is recorded together and simultaneously with focus point information when the data is recorded (when converted into JPEG data). In an example illustrated in FIG. 7, the focus point exists in an upper left part of the image data.

A controller 113 causes information of at least one focus point stored in the memory card 3 to be inputted to the controller 113. The controller 113 divides the image data into areas as illustrated in FIG. 3 with at least one focus point used as the center, based on the information of at least one focus point recorded on the image data. In this case, the sizes of the area A, the area B, and the area C are determined based on the viewing angle, which is determined on the basis of the case where the viewer views the center position of the screen, in the same manner as the first embodiment. Then, the controller 113 prepares expected image data for the image data, by using the data curves illustrated in FIG. 4. When a display 109 displays an image based on the expected image data, the subject is displayed in an enlarged state in the upper left part, not the center position, of the screen of the display 109.

According to the second embodiment, since the subject is enlarged with the focus point used as the center, not the center position of the screen, it is possible to suppress decrease in a sense of presence when the image is displayed on the screen.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an image input module configured to access an image and information identifying a focus point of the image;
an enlargement module configured to enlarge a part of the image around the focus point to obtain an enlarged image; and
an output module configured to output the enlarged image.

2. The apparatus of claim 1, wherein the enlargement module is further configured to:
enlarge a first area around the focus point based on a first enlargement rate; and
enlarge a second area based on a second enlargement rate, wherein the second area is more distant from the focus point that the first area, and wherein the first enlargement rate is greater than the second enlargement rate.

3. The apparatus of claim 1, wherein the enlargement module is further configured to correct the image based on an enlargement curve centered around the focus point, wherein an enlargement rate associated with the enlargement curve increases toward the focus point.

4. The apparatus of claim 1, further comprising a display configured to display the enlarged image outputted by the output module.

5. The apparatus of claim 1, wherein the enlargement module is further configured to:
divide the image into three areas centered around the focus point; and
enlarge the three areas based on differing enlargement rates.

6. The apparatus of claim 1, wherein the enlargement module is further configured to enlarge the image based, at least in part, on a screen size of a display which displays the image.

7. The apparatus of claim 1, further comprising a gradation setting module configured to increase gradation of the part of the image around the focus point.

8. The apparatus of claim 1, further comprising an outline emphasis degree setting module configured to increase an outline emphasis degree of the part of the image around the focus point.

9. The apparatus of claim 1, wherein the image input module is further configured to access information associated with a plurality of focus points.

10. The apparatus of claim 1, wherein the part of the image is associated with a predetermined viewing angle.

11. The apparatus of claim 1, wherein the part of the image is associated with an optimum viewing angle.

12. An image processing method comprising:
accessing an image and information identifying a focus point of the image;
enlarging a part of the image around the focus point of the image to obtain an enlarged image; and
outputting the enlarged image.

13. Non-transitory physical computer readable storage having stored thereon a method which is executable by a computer, the method comprising:
accessing an image and information identifying a focus point of the image;
enlarging a part of the image around the focus point of the image to obtain an enlarged image; and
outputting the enlarged image.
